(19) United States
(12) Patent Application Publication
(10) Pub. No.: US 2005/0239957 A1
(43) Pub. Date: Oct. 27, 2005

(54) Composition and method of preparing high solid emulsions

(76) Inventors: Irving W. Pillsbury, Chesapeake, VA (US); Michael Heard, Chesapeake, VA (US); Stanley F. Barto, Chesapeake, VA (US)

Correspondence Address: Patent Department;Ciba Specialty Chemicals Corporation, 540 White Plains Road, P.O. Box 2005, Tarrytown, NY, 10591-9005, US

(21) Appl. No.: 11/104,054

(22) Filed: Apr. 12, 2005

Related U.S. Application Data
(60) Provisional application No. 60/564,190, filed on Apr. 21, 2004.

(51) Int. Cl. C08L 1/00

(52) U.S. Cl. 524/801

(57) ABSTRACT

The present invention relates to a composition containing anionic, amphoteric, cationic or non-ionic stable high solid polymeric emulsions wherein the solids content is equal to or greater then 35%, the emulsion particle size is less than or equal to 0.5 microns and the surfactant level ranges from 2 to 9 percent. The present invention also relates to a method for preparing said high solid polymeric emulsions, which process comprises the steps of (a) admixing; (i) an oil phase composition comprising at least one hydrocarbon liquid; (ii) an effective amount of a surfactant or mixture of surfactants or mixture of surfactant and co-surfactant; (vii) an aqueous phase comprising at least one monomer selected from the group consisting of ethylenically unsaturated cationic monomers, ethylenically unsaturated anionic monomers, ethylenically unsaturated amphoteric monomers and ethylenically unsaturated nonionic monomers, and optionally, (viii) at least one cross-linking agent, so as to form an inverse emulsion; (b) heating the inverse emulsion formed in step (a) to a temperature of about 28 to about 50° C.; (c) degassing the heated inverse emulsion formed in (b); and, (d) polymerizing the monomer or monomers of the emulsion formed in (c) to form the polymeric inverse emulsion.

This application claims the benefit of U.S. Provisional Application No. 60/564,190, filed on Apr. 21, 2004 which application is herein incorporated by reference.

The present invention relates to a composition containing anionic, amphoteric, cationic or non-ionic stable high solids polymeric emulsions. The present invention also relates to a method for preparing said high solids polymeric emulsions.

### BACKGROUND OF THE PRESENT INVENTION

Polymerization of monomers in emulsions is well known to those skilled in the art. Emulsions can be of two different types, i.e., oil-in-water (O/W) or water-in-oil (W/O). The emulsions of the instant invention are water-in-oil (W/O) emulsions or inverse emulsions. Inverse emulsions are generally formed by preparing a monomer phase, an oil phase and then emulsifying the two together using a surfactant and optionally co-surfactants and mechanical homogenization, followed by mixing and degassing the emulsified mixture. The emulsified monomers are then polymerized within the water phase by the addition of initiators.

Typical water droplet size or particle size of the aqueous droplet for an inverse emulsion ranges from 0.5 micron and above for conventional inverse emulsions. Examples of classical inverse macro-emulsion techniques can be found in U.S. Pat. Nos. 3,284,393 and 3,826,771 herein incorporated by reference.

Emulsions of smaller particle sizes are known as miniemulsions and microemulsions. Typical miniemulsion mean particle size falls in the range of from 0.2 to 0.5 microns. Typical microemulsion mean particle size range is below 0.2 microns. Both mini- and microemulsions are made by the same process described above. However, surfactants with the right hydrophilic-lipophilic balance (HLB) value must be used to achieve stable microemulsions and miniemulsions often requiring in addition to a surfactant, a co-surfactant or a blend of surfactants.

For polyacrylamide-based microemulsions, the prior art teaches that chemical emulsification is obtained by addition of a surfactant or surfactant blend at a level greater than 8% total weight and having an HLB ranging from 7-12 to the oil phase. The monomers are added to the water phase. The oil and water phases are mixed by mechanical homogenization followed by degassing. Initiators are then fed to the reaction mixture thus starting the polymerization. Using this technique, the resulting solid polymer content or active polymer content is limited to about 30% or less for microemulsions and about 35% or less for miniemulsions. Greater than 8% total surfactant is usually required for microemulsions and greater than 6% surfactant or surfactant blends for miniemulsions.

Regular emulsions (oil/water) are very similar to the above inverse emulsions but the polymerization of the monomers takes place in the oil phase rather than in the water phase. The inventive process may also apply to standard emulsions (oil/water) as well as inverse emulsions.

Candau et al., U.S. Pat. No. 4,521,317, teach a process for polymerizing a water-soluble monomer in a water-in-oil inverse microemulsion. The patentees teach that the monomer emulsion is a transparent microlatice and that the aqueous phase comprises 1-50 percent by weight of the total emulsion. The percent solids formed by the process of U.S. Pat. No. 4,521,317 ranges from 3 to 5% based on the total emulsion. The particle size formed is below 0.3 microns.

Durand et al., U.S. Pat. No. 4,681,912, teach a process to manufacture inverse microlatices of water-soluble copolymers by admixing an aqueous phase containing a water-soluble monomer and an oil phase with non-ionic surfactant(s) having an HLB range of 8-11 to form a transparent monomer microemulsion and then polymerizing. The patentees teach determining the minimum surfactant concentration according to the formula: y=5.8x²−110x+534 where x is the HLB value and y is the surfactant concentration.

Holtzscherer et al., Colloids and Surfaces, 29 (1988), 411-428 discuss the use of the cohesive energy concept to determine the most efficient use of surfactants in microemulsions. The minimum surfactant content of 10.8 percent and an optimum HLB of 8.68 were found. Solid polymer content formed in the microemulsion is 15% by weight of the total emulsion.

Dauplaise et al., U.S. Pat. No. 4,954,538, teach crosslinked glyoxylated (meth)acrylamides prepared using inverse microemulsion techniques which are disclosed to be useful as wet- and dry-strength agents in paper production. The total polymeric solids content formed in these microemulsions does not exceed 20% by weight of the total emulsion.

Honig et al., U.S. Pat. No. 5,274,055, discuss the use of ionic organic microemulsions to provide improved products useful in drainage and retention in papermaking processes. Honig et al. discloses inverse emulsions wherein the polymeric solid content formed is as high as 50% but the particle size is greater than 0.9 microns.

Allen et al., U.S. Pat. No. 4,528,321, discloses inverse emulsions at 50% solids achieved by distilling off water and volatile oils. The formation of these inverse emulsions generates polymer solids of approximately 25% based on the total weight of the emulsion.

Tang et al., J. Applied Polymer Science, Vol. 43 (1991), 1059-1066 study the variations in conditions used to prepare miniemulsions and resulting differences in polymerization kinetics.

Huang et al, U.S. Pat. No. 5,545,688, discloses stable polyacrylamide microemulsions. The inverse emulsions contain 15 to 25% polymer solids.

Kozakiewics et al. U.S. Pat. No. 4,956,400, discloses inverse emulsions of functionalized polymers. The solids content of the inverse emulsion does not exceed 25%.

Lim et al., U.S. Pat. No. 4,147,681, discloses self-inverting water-in-oil emulsions. The active polymer content is in some examples more than 30%. No mention is made as to particle size.

The references above disclose stable microemulsions or miniemulsions. None however, disclose compositions where the polymer formed within the inverse emulsion makes up over 35 percent of a stable inverse emulsion based on the total weight of the emulsion and has a particle size of less than 0.7 microns.

Therefore, while the prior art emulsion processes have provided improvements, there still exists a need in the art for further improvement. In particular, there is still a need for a process producing anionic, nonionic and cationic polymer contents of 30% or greater for use in municipal and industrial wastewater treatment, oil recovery and oil processing, mineral processing, and papermaking or solid/liquid separation processes within these industries.

It would be a significant advantage to form emulsions containing greater than 30% active polymeric solids that are stable, do not separate upon standing and require less surfactant in the emulsification step. It would further be advantageous to achieve these high solid levels by not distilling off water or other volatile liquids, a very energy intensive step. This increase in solid polymer content would be very desirable in the marketplace, reducing transportation costs, and allowing higher capacity utilization in the plant. It would further be advantageous to lower the level of surfactant needed to form the inverse emulsion and to have a process less sensitive to the HLB value of the surfactant.

The present inventors have surprisingly discovered a process that allows for stable, high solid polymer compositions in emulsions. The inventors have further surprisingly identified stable polymeric emulsion compositions having high active polymer content and reduced surfactant amounts. Further, the HLB of the surfactants used to form the emulsion is less important with this inventive process and allows for a wider range of HLB values while still maintaining product stability. The inventive process and emulsion composition also provides for a product more resilient to varying HLB making the precise measuring and testing usually required in typical mini and microemulsion systems unnecessary.

The process of the present invention provides a polymeric emulsion particle size of less than or equal to about 0.7 microns and an active polymer solid content of greater than about 30% based on the total weight of the emulsion. The composition of the present invention provides a polymeric emulsion particle size of less than or equal to about 0.5 microns and an active polymer solid content of greater than about 35% based on the total weight of the emulsion.

### SUMMARY OF THE PRESENT INVENTION

According to the present invention, a method is provided for preparing polymeric inverse emulsions, which method comprising the steps of
(a) admixing;
   (i) an oil phase composition comprising at least one hydrocarbon liquid;
   (ii) an effective amount of a surfactant or mixture of surfactants or mixture of surfactant and co-surfactant;
   (iii) an aqueous phase comprising at least one monomer selected from the group consisting of ethylenically unsaturated cationic monomers, ethylenically unsaturated anionic monomers, ethylenically unsaturated amphoteric monomers, and ethylenically unsaturated nonionic monomers, and optionally,
   (iv) at least one cross-linking agent,
so as to form an inverse emulsion;
(b) heating the inverse emulsion formed in step (a) to a temperature of about 28 to about 50° C.;
(c) degassing the heated inverse emulsion formed in (b);
and,
(d) polymerizing the emulsion formed in (c) to form the polymeric inverse emulsion.

A second method embodied by the invention is a method for preparing polymeric inverse emulsions, which method comprising the steps of
(a′) heating an oil phase composition comprising at least one hydrocarbon liquid and an effective amount of a surfactant, mixture of surfactants or mixture of surfactant and co-surfactant;
(b′) admixing
   an aqueous phase comprising at least one ethylenically unsaturated monomer selected from group consisting of ethylenically unsaturated cationic monomers, ethylenically unsaturated anionic monomers, ethylenically unsaturated amphoteric monomers and ethylenically unsaturated nonionic monomers and mixtures thereof, and optionally at least one cross-linking agent with the heated oil phase composition in step (a′) so as to form a heated inverse emulsion, wherein the temperature of the combined oil phase and aqueous phase is about 28 to about 50° C.;
(c′) degassing the heated emulsified mixture formed in (b′); and,
(d′) polymerizing the mixture formed in (c′) to form the polymeric inverse emulsion.

Furthermore a polymeric inverse emulsion of the invention is provided which composition comprises
a polymeric inverse emulsion which comprises
   (I) a hydrocarbon phase and an aqueous phase, wherein the hydrocarbon phase comprises about 2 to about 9 weight percent, preferably about 2 to 6 percent surfactant,
   and
   (II) at least 35 weight % of a polymer,
   wherein the polymer is in the form of a polymer phase droplet which droplet is a particle having an average mean diameter size of about equal to or less than about 0.5 microns, preferably about equal to or less than about 0.35 microns, and all weight percents are based on the total weight of the emulsion.

The invention also embodies a polymeric inverse emulsion product which product is formed by the process above.

### DETAILED DESCRIPTION OF THE INVENTION

The preferred emulsions of the invention are inverse or water-in-oil emulsions. The preferred polymeric inverse emulsions formed have a particle size having a mean diameter encompassing the mini and microemulsion ranges or a diameter having a number average of about equal to or less than about 0.7 microns. Preferably the particle size is equal to or less than about 0.5 microns. Most preferably, the particle size is about equal to or less than about 0.35 microns.

The process of the invention could just as well be applied to traditional emulsion, either inverse (water/oil) or standard (oil/water). The invention is not limited to formation of emulsions of less than 0.7 microns but could equally well be applied to polymeric emulsion droplets of greater than 0.7 microns. However, it is generally known by those Skilled in the art that the smaller the polymeric emulsion droplet, the more stable the emulsion and therefore a smaller droplet size is advantageous.

The polymeric inverse emulsions of the invention are stable. Stable emulsions for the purposes of the invention are emulsions that do not separate into two phases upon standing at about 25° C. for a period equal to or greater than about 6 months. Preferably, the inverse emulsions of the invention are stable upon standing at about 25° C. for a period equal to or greater than about 9 months.

The hydrocarbon phase of step (a)(i) or (a′) comprises isoparafinic hydrocarbons or mixtures thereof. Typically the hydrocarbon phase will comprise mineral oil, toluene, fuel oil, kerosene, odorless mineral spirits and mixtures thereof.

The one or more surfactants and co-surfactants are selected in order to obtain an HLB (Hydrophilic Lipophilic Balance) value ranging from about 3 to about 12. Outside of this range, inverse mini- and microemulsions are not usually obtained.

An effective amount of surfactant is a concentration of surfactant optimized to give inverse emulsions wherein the size of the water droplet in the oil phase is small enough to give stable inverse emulsions. Increasing the surfactant generally gives a smaller droplet size. An effective amount of surfactant is an amount that gives a droplet size of less than or equal to about 0.7 microns. Typical surfactants useful in the practice of this invention, in addition to those specifically discussed above, may be anionic, cationic or non-ionic, and may be selected from polyoxyethylene (20) sorbitan trioleate, polyoxyethylene sorbitol hexaoleate, sorbitan sesquioleate, sorbitan trioleate, sorbitan monostearate, sorbitan monooleate, sodium di-2-ethylhexylsulfosuccinate, oleamidopropyldimethylamine; sodium isostearyl-2-lactate, diethanololeamide, glyceryl monooleate and ethoxylated fatty alcohols and mixtures thereof.

The concentration of surfactant used in (a)(ii) or (a′) ranges from about 2 to 12 percent based on the total weight of the emulsion. Preferably, the surfactant used in (a)(ii) or (a′) ranges from about 2 to about 9 percent and most preferably ranges from about 2 to about 6 percent based on the total weight of the emulsion.

The aqueous phase before polymerization (iii) comprises an aqueous mixture of the monomers, and, optionally, a crosslinking agent. The aqueous phase may contain water alone or mixtures of water with water-miscible liquids such as methanol. Preferably, water alone is used. The aqueous monomer mixture may also comprise such conventional additives as are desired. For example, the mixture may contain chelating agents to remove polymerization inhibitors, pH adjusters, thermal and redox initiators such as peroxides, organic compounds and redox couples, and other conventional additives.

Cationic, non-ionic, anionic and amphoteric ethylenically unsaturated monomers and any combination and ratios thereof may be used to form the polymeric inverse emulsion.

The monomers are preferably water-soluble. Such monomers have a water solubility of about 5 weight percent or higher and include monomers well known to those skilled in the art such as acrylamide, (meth)acrylic acid and salts thereof and dimethylaminoethyl acrylate quaternary salts.

The monomer content of the aqueous phase is generally 20-80% and preferably 20-60% by weight.

The weight to weight ratio of the total amount of the aqueous phase to the total weight of the hydrocarbon phase is chosen as high as possible, so as to obtain, after polymerization, an emulsion of high polymer content. Practically, this weight ratio may range, for example, from about 4 to about 1 or about 1 to about 4. The most preferred weight ratio is about 4 to about 1.

Cationic monomers which may be used herein to form the polymeric emulsion are of the following general formulae: 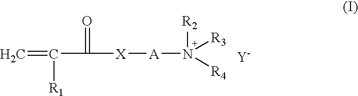
where R¹ is hydrogen or methyl;
R₂ is hydrogen or C₁-C₄ alkyl;
R₃ and R₄ are the same or different and independently represent hydrogen, C₁-C₄ alkyl,
C₁-C₁₂ aryl, phenylalkyl, or hydroxyethyl;
R₂ and R₃ or R₂ and R₄ can combine to form a 5 or 6 membered ring containing one or more hetero atoms;
Y⁻ is the conjugate base of an acid;
X is oxygen or —NR₁ wherein R₁ is independently defined as above,
and
A is a C₁-C₁₂alkylene group; or 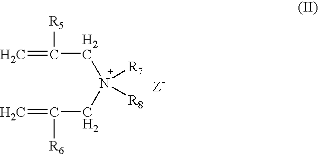
where R₅ and R₆ are hydrogen or a C₁-C₄ alkyl;
R₇ and R₈ are, independently, hydrogen, alkyl, hydroxyalkyl, carboxyalkyl, carboxyamide alkyl, phenylalkyl, or alkoxyalkyl and
Z⁻ represents an anion.

Cationic monomers useful in the practice of the present invention include diallyldimethylammonium chloride; acryloxyethyltrimethylammonium chloride; (meth)acrylates of dialkylaminoalkyl compounds, and salts and quaternary salts thereof and, in particular, monomers of N,N-dialkylaminoalkyl(meth)acrylamides, and salts and quaternary salts thereof, such as N,N-dimethylaminoethylacrylamides; (meth)acrylamidopropyltrimethylammonium chloride and the acid or quaternary salts thereof and N,N-dimethylaminoethyl(meth)acrylate and salts and quaternary salts thereof and the like.

Preferred ethylenically unsaturated cationic monomers for forming the polymeric inverse emulsion of the invention include dimethylaminoethyl (meth)acrylate methyl chloride quaternium salt, dimethylaminoethyl (meth)acrylate benzyl chloride quaternium salt, dimethylaminoethyl (meth)acrylate dimethylsulfate quaternium salt, (meth)acrylamidopropyltrimethyl ammonium chloride and diallyidimethylammonium chloride.

Alkyl for the purposes of the invention is defined as having up to 25 carbon atoms and is a branched or unbranched radical, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, icosyl or docosyl. Phenylalkyl is preferably C₇-C₉ phenylalkyl, for example, benzyl, α-methylbenzyl, α,α-dimethylbenzyl or 2-phenylethyl. Preference is given to benzyl.

Representative ethylenically unsaturated non-ionic monomers include acrylamide, methacrylamide, N-methyl(meth)acrylamide, N,N-dimethyl(meth)acrylamide, N-isopropyl(meth)acrylamide, N-(2-hydroxypropyl)(meth)acrylamide, N-methylolacrylamide, N-vinylformamide, N-vinylacetamide, N-vinyl-N-methylacetamide, fumaramide, poly(ethylene glycol)(meth)acrylate, poly(ethylene glycol) monomethyl ether mono(meth)acrylate, N-vinyl-2-pyrrolidone, glycerol mono((meth)acrylate), 2-hydroxyethyl(meth)acrylate, vinyl methylsulfone, vinyl acetate, diacetone acrylamide, and diesters of maleic, fumaric, succinic and itaconic acids. Hydrophobic, nonionic monomers include acrylates such as methyl (meth)acrylate, ethyl (meth)acrylate, hexyl (meth)acrylate, octyl (meth)acrylate, stearyl (meth)acrylate, lauryl (meth)acrylate, stearyl ethoxy (meth)acrylate, stearyl ethoxy allyl ether and mixtures thereof.

Preferred non-ionic monomers suitable for use in the practice of the present invention generally comprise acrylamide, methacrylamide; N-alkylacrylamides, such as N-methylacrylamide; N,N-dialkylacrylamides, such as N,N-dimethylacrylamide; methyl acrylate; methyl methacrylate; hydroxyalkyl(meth)acrylates; acrylonitrile; N-vinyl methylacetamide; N-vinyl methyl formamide; N-vinyl pyrrolidone, and mixtures thereof.

The preferred ethylenically unsaturated anionic monomers are selected from the group consisting of acrylic acid, methyl acrylic acid, 2-acrylamido-2-methyl propane sulfonic acid, sulfoethyl acrylic acid, sulfoethyl methyl acrylic acid, vinylsulfonic acid, styrene sulfonic acid, maleic acid and salts of the above.

The present invention further contemplates copolymerizing ionic and non-ionic monomers to produce ionic copolymers. Illustratively, acrylamide can be copolymerized with an anionic monomer such as acrylic acid or a cationic monomer such as dimethylaminoethyl (meth)acrylate methyl chloride quaternium salt. Anionic and cationic copolymers useful in the practice of the present invention comprise from about 1 to about 99 parts by weight of non-ionic monomer and from about 99 to about 1 part by weight anionic or cationic monomer based on 100 total parts by weight of the anionic or cationic and non-ionic monomer taken together; preferably from about 15 to about 99 parts by weight non-ionic monomer and from about 1 to about 85 parts by weight of anionic or cationic monomer on the same basis.

The present invention also contemplates polymers which are 100 weight % cationic or anionic, such as for example a homopolymer formed from 100 weight % sodium acrylate or 100 weight % dimethylaminoehtyl (meth)acryalte methyl chloride quaternium salt. 100%.

Amphoteric polymers are also encompassed by the present invention. These may be prepared by combining anionic and cationic monomers and/or amphoteric monomers to form the inverse emulsions of the invention.

Amphoteric monomers considered are for example,
N,N-dimethyl-N-acryloyloxyethyl-N-(3-sulfopropyl)-ammonium betaine,
N,N-dimethyl-N-acryloyloxyethyl-N-(2-carboxymethyl)-ammonim betaine,
N,N-dimethyl-N-acrylamidopropyl-N-(3-sulfopropyl)-ammonium betaine,
N,N-dimethyl-N-acrylamidopropyl-N-(2-carboxymethyl)-ammonium betaine,
2-(methylthio)ethyl methacryloyl-S-(sulfopropyl)-sulfonium betaine,
2-[(2-acryloylethyl)dimethylammonio]ethyl 2-methyl phosphate,
2-(acryloyloxyethyl)-2′(trimethylammonim)ethyl phosphate,
[(2-acryloxylethyl)dimethylammonio]methyl phosphonic acid,
2-methacryloyloxyethyl phosphorylcholine (MPC),
2-[(3-acrylamidopropyl)dimethylammonio]ethyl 2′-isopropyl phosphate (AAPI),
1-vinyl-3-(3-sulfopropyl)imidazolium hydroxide,
(2-acryloxyethyl) carboxymethyl methylsulfonium chloride,
1-(3-sulfoproyl)-2-vinylpyridinium betaine,
N-(4-sulfobutyl)-N-methyl-N,N-diallylamine ammonium betaine (MDABS),
N,N-diallyl-N-methyl-N-(2-sulfoethyl) ammonium betaine, and the like.

The aqueous monomer phase in step (a) (iii) or (b′) contains at least about 20 percent monomer or mixtures of monomers defined above based on the total weight to the aqueous phase. Preferably, the aqueous monomer phase contains at least about 30 percent monomer or mixtures of monomers defined above based on the total weight of the aqueous phase. Most preferably, the aqueous monomer phase contains at least about 50 percent monomer based on the total weight of the aqueous phase.

The aqueous phase can contain in addition to the monomers mentioned above polyfunctional branching agents, functionalizing agents and cross-linking agents.

The polyfunctional branching agents contain at least one double bond and at least one reactive group including glycidyl acrylate; glycidyl methacrylate; acrolein; methylolacrylamide, and mixtures thereof and the like.

Polymerization of the monomers optionally occurs in the presence of a polyfunctional cross-linking agent to form a cross-linked composition. The polyfunctional cross-linking agent comprises molecules having at least two reactive groups.

For example, cross-linking agents can comprise difunctional monomers selected from N,N′-methylenebisacrylamide, methylol acrylamide, N,N′-methylenebismethacrylamide, polyethyleneglycol diacrylate, polyethyleneglycol dimethacrylate, N-vinylacrylamide, glycidyl acrylate, divinylbenzene, acrolein, glyoxal, diepoxy compounds, epichlorohydrin; tetraallylammonium chloride or mixtures of any of the foregoing.

For the purposes of the invention, functionalizing agents are defined as agents which form functional groups on the polymer formed in the inverse emulsion by the instant process either by functionalization during polymerization or functionalization of the polymer after polymerization. The functional groups possessed by the polymer particles may be imparted by the functionalizing agents by any of the methods below:
1) reacting the formed polymer of the inverse emulsion with an agent capable of adding a functional group thereto or
2) polymerizing a monomer capable of forming a polymer in the inverse emulsion in the presence of an agent capable of adding a functional group to the resultant polymer, or
3) polymerizing a monomer already possessing a functional group and capable of forming, alone or in conjunction with another monomer, a polymer in the inverse emulsion, or
4) polymerizing a monomer containing a group capable of being transformed into a functional group and capable of forming a polymer in the inverse emulsion,
   a. alone or in conjunction with another monomer, or
   b. after said group has been transformed into a functional group.

In process (1), a formed polymer of the inverse emulsion is reacted with a material capable of adding a functional group thereto. For example, acrylamide polymers may be reacted with materials such as aldehydes such as glyoxal and formaldehyde or chlorine, bromine and the like. In process (2), 2-hydroxyethyl methacrylate polymers may be reacted with materials such as epichlorohydrin, glyoxal; water-soluble diisocyanates and the like. Process (3), N,N-dimethylaminoethyl methacrylate polymers may be reacted with materials such as epichlorohydrin, bischloromethyl ether, 1,4-dichloro-2-butene and the like. In process (4), diallyl amine polymers may be reacted with epichlorohydrin, bischloromethyl ether, glyoxal, α,α′-dichloroxylene and the like.

As regards process (2) discussed above, the above-mentioned reactants can be added to the monomers used to prepare the polymeric emulsion particles before or during the emulsion polymerization to add the functional groups to the resultant polymer.

In process (3), any of the above described reactions can be carried out on the monomer first and then the resultant functionalized monomer may be polymerized under conditions of the instant inverse emulsion polymerization.

In process (4), the monomer being polymerized contains, or is made to contain, a group which is capable of being transformed into a functional group. For example, vinyl acetate is copolymerized with N-vinyl pyrrolidone, the acetate groups are hydrolyzed into alcohol groups which are then converted into functional groups by reaction with glyoxal, epichlorohydrin, etc. Similarly, vinyl formamide may be polymerized and then hydrolyzed, after which it may be reacted with allyl amine monomers.

The aqueous phase may be added in equal or unequal parts such as halves, thirds, fourths, etc., or the aqueous phase may be added in a dropwise manner to the oil phase or all at once.

The oil phase can be added to the aqueous phase or the aqueous phase can be added to the oil phase.

Polymerization may be initiated by any conventional manner, for instance by photo, redox or thermal initiation.

The polymers of the present invention preferably have a molecular weight in excess of about 100,000 and preferably between about 250,000 and 40,000,000 daltons.

Another measure of molecular weight is intrinsic viscosity. Intrinsic viscosity (IV) is a function of molecular weight, salt concentration and temperature. Therefore viscosity is related to molecular weight at a fixed salt concentration and temperature. The higher the viscosity, the higher the molecular weight. Intrinsic viscosity is measured by suspended level viscometer in buffered pH 7 2M NaCl at 25° C. It has been surprisingly discovered that it is possible to prepare exceptionally high molecular weight polymers by the inventive process. Example 4F shows an extremely high intrinsic viscosity of 38 dl/g corresponding to a molecular weight of approximately 40,000,000 daltons.

Mixing and heating can be accomplished by any of the standard methods known to one skilled in the art. Generally, the mixing of the emulsion of the invention does not require high shear. However, shear can be applied to the emulsion before polymerization in order to decrease the droplet size.

Step (b) or (a′) requires that the mixture formed is heated from a range of about 28° C. to 50° C. Preferably the mixture is heated from a range of about 28° C. to about 40° C. Most preferably the mixture is heated from a range of about 30° C. to about 40° C. and especially preferred a range of about 35° C. to about 40° C. Heating of the oil and water phase mixture is key to the inventive process. While not wishing to be bound by theory, it is belived that the heating the emulsion slightly changes the thermodynamic properties of the emulsion, increasing the stability of the formed emulsion allowing for higher levels of solids to be present in the formed polymeric emulsion. The heating of the emulsion is carried out before polymerization is initiated by directly heating the aqueous and oil phases while admixing or by preheating the oil phase and adding to the aqueous phase.

It is also important that degassing (step c) or c′)) of the emulsion takes place after the heating of the emulsion, step b) or a′). The presence of oxygen during heating of the emulsion prevents premature polymerization.

Heating the emulsion can be accomplished by any means known to those familiar with the art.

It is also envisioned that in step b) or a′) the mixture formed could be heated to a temperature slightly below about 28° C., say 27° C. but accompanied by mechanical shear to reduce the emulsion droplet size.

It is preferred however, to simply heat the mixture formed in step b) or a′) since this is more efficient.

The term active polymer solids of the invention is meant that the polymeric emulsion formed is equal to or greater than about 30% active polymer solids based on the total weight of the emulsion. Preferably, the active polymer solid content is greater than 35%. Most preferably, the active polymer solid content is about equal to or greater than about 40%.

The polymeric emulsion formed by the invention may be dehydrated under reduced pressure and at an elevated temperature of 50-80° C. with the inclusion of a polymeric stabilizer to make the system resilient to stresses of distillation. This may optionally include the use of recyclable solvent to assist in the water removal. A liquid dispersion of polymer in oil containing <5% water can be obtained. The active solids can be increased from 45% to 70% by this method.

Degassing the mixture with an inert gas, step c) or c′) must follow heating of the emulsion and mixing. Preferably, the inert gas is nitrogen. The degassing may be preceded by evacuation. However, if this is the case, then the evacuation must also follow heating of the emulsion and mixing.

Degassing may be accomplished by sparging with an inert gas.

The emulsion polymerization is generally carried out from about 30° C. to about 95° C., preferably from about 35° C. to about 50° C. The disclosed examples begin an initiator feed to start the polymerization reaction at about 30 to 40° C. and the reaction temperature is maintained at ˜40° C. throughout the polymerization process in step d) or d′). Conducting the process in this fashion allows for the production of a polymeric emulsion with a polymer content of about 30% or greater thus making it economically viable in the marketplace. The typical mean particle size of the emulsions produced with this method and recipe are about in the 0.2 to 0.5 micron range, but this process would work for standard emulsions and microemulsions as well.

It is also envisioned that the emulsification temperature can be higher than the actual polymerization temperature. For example, the emulsification can take place at about 35° C., then the temperature of the emulsion can be dropped to about 30° C. and polymerization initiated.

The time needed to complete polymerization depends on the initiation temperature and concentration of reactants but generally takes about 2 to about 3 hours from the start of initiation.

Preferably, the polymerization is effected by the addition of a polymerization activator, such as sulfur dioxide. Alternatively, polymerization may also be effected by photochemical irradiation processes, irradiation, or by ionizing radiation with a ₆₀Co source.

A variety of thermal and redox free-radical initiators including azo compounds, such as azobisisobutyronitrile; peroxides, such as t-butyl peroxide; inorganic compounds, such as potassium persulfate; and redox couples, such as ferrous ammonium sulfate/ammonium persulfate, may also be added to the aqueous phase, or to the oil phase or the combined mixture formed.

Either water-soluble or oil-soluble initiators can be employed during the inverse emulsion polymerization step d) or d′).

The amount of initiators is in general from 0.001 to 5% by weight, preferably from 0.001 to 0.5% by weight, based on of all of the monomers that are to be polymerized. It is also possible to use a plurality of different initiators in the emulsion polymerization.

The emulsion polymerization can be carried out either as a batch process, continuous or in the form of a feed technique, including stepwise or gradient procedures. The method of the invention is especially appropriate for a continuous system whereby the oil phase and aqueous phase with polymerizable monomers are continuously combined to form an inverse emulsion at temperatures ranging from about 28 to about 50° C., and then polymerized to produce the inverse emulsion polymer with continuously withdrawing a portion of the said emulsion polymer.

The manner in which the initiator is added to the polymerization vessel in the course of free-radical aqueous emulsion polymerization is known to the skilled worker. It can either be included entirely in the initial charge to the polymerization vessel, or else introduced continuously or in stages, at the same rate at which it is consumed in the course of the free-radical aqueous emulsion polymerization. In each case this will depend, as is familiar to the skilled worker, on both the chemical nature of the initiator system and the polymerization temperature. With preference, a portion is included in the initial charge and the remainder is supplied to the polymerization zone at the same rate at which it is consumed.

In order to remove the residual monomers, initiator is normally also added after the end of the actual emulsion polymerization, i.e. after a monomer conversion of at least about 95%.

The individual components can be added to the reactor, in the case of the feed technique, from the top, in the side or from below, through the reactor base.

The polymer products of this invention are useful in facilitating a wide range of solid-liquid separation operations. They may be used to dewater biologically treated suspensions, such as sewage and other municipal or industrial sludges; to drain cellulosic suspensions, such as those found in paper production, e.g., paper waste; and to settle and dewater of various inorganic suspensions, e.g., refinery waste, coal waste, and mineral processing etc. For example, a method of flocculation can comprise adding the cationic polymeric flocculants of the present invention to an aqueous dispersion of suspended solids, such as sewage sludge, in amounts ranging from about 0.1 to about 50,000 ppm by weight of dispersion and then separating the flocculated suspended solids from the dispersion.

The inventive polymeric emulsions can be used for water clarification, for example cleaning industrial white water formed in paper making processes and cleaning of textile waste water.

The anionic and cationic polymers of the present invention are especially useful as a retention aid to conventional papermaking stock such as chemical pulps, mechanical pulps, thermomechanical pulps or recycled pulps.

The polymers of the invention can be used to modify the rheology of paints, pastes, coatings, adhesives or ink formulations. For example, the emulsion polymers can be used in textile printing pastes, wall paper pastes, printing paste thickeners, paint thickeners, paper and paperboard coatings and home and personal care compositions such as shampoos, hair conditioners, liquid hand soaps, shower gels, and skin care creams.

The anionic polymers of the present invention are especially useful in oil recovery methods such as in drive fluids, manufacture of drilling muds, ground consolidation, prevention of inflows in producing oil wells and as completion or fracturation fluids.

The following examples illustrate the present invention. They are not to be construed to limit the claims in any manner whatsoever except as set forth therein. The particle size of the polymer phase droplet is measured using an HORIBA LA 910 laser scattering particle distribution analyzer. All % values are based on weight unless otherwise specified.

### EXAMPLE 1A

### Comparative

A conventional inverse emulsion comprising 40% is prepared using standard means of polymerization. The copolymer component of the emulsion contains 80% dimethylaminoethyl acrylate quaternized with methyl chloride (DMAEA.MeCl) and 20% acrylamide thus making the copolymer 80% cationic in nature. The standard means of inverse emulsion polymerization involves preparation of the aqueous phase, preparation of the oil phase containing 2.3% emulsifying surfactant, and homogenization of the two for one hour by use of a Silverson mechanical homogenizer to form the emulsion. Primary constituents of the oil phase and aqueous phase are outlined below.

Aqueous Phase:

| | | |
|---|---|---|
| Acrylamide @ 50.0% | 160.0 | g |
| Dimethylaminoethyl Acrylate @ 80.0% | 400.0 | g |
| Water | 105.5 | g |

Oil Phase:

| | | |
|---|---|---|
| Naphthenic/Paraffenic oil | 270.0 | g |
| Sorbitan Monooleate (surfactant) | 23.0 | g |

Upon homogenization, the particle size of the resulting emulsion is measured before polymerization by use of a HORIBA LA-910 particle size analyzer. The homogenization and particle size determination process is continued until a mean particle size of about 1 micron is obtained. Degassing of the resulting emulsion is accomplished by use of a nitrogen sparge. After degassing, the reaction is initiated by use of sulfur dioxide and potassium bromate at a temperature of ˜20° C. The resulting reaction mass is allowed to heat up as a result of the reaction exotherm to a temperature of ˜40° C. where the polymerization is maintained with cooling. A stable resulting product is obtained from this process. The characteristics of the end product are outlined as example 1A.

### EXAMPLE 1B

### Comparative

A conventional inverse emulsion comprising 30% copolymer by weight was prepared using standard means of polymerization. The copolymer component of the emulsion contains 40% sodium acrylate and 60% acrylamide thus making the copolymer 40% anionic in nature. The standard means of inverse emulsion polymerization involves preparation of the aqueous, preparation of the oil phase containing 2% emulsifying surfactant, and homogenization of the two for one hour by use of a Silverson mechanical homogenizer to form the emulsion. Primary constituents of the oil phase and aqueous phase are outlined below.

Aqueous Phase:

| | | |
|---|---|---|
| Acrylic Acid @ 100.0% | 120.0 | g |
| Acrylamide @ 50.0% | 360.0 | g |
| Caustic Soda | 75.0 | g |
| Water | 97.0 | g |

Oil Phase:

| | | |
|---|---|---|
| Naphthenic/Paraffenic oil | 300.0 | g |
| Sorbitan Monooleate (surfactant) | 20.0 | g |

Upon homogenization, particle size of the resulting emulsion is measured before polymerization by use of a HORIBA LA-910 particle size analyzer. The homogenization and particle size determination process is continued until a mean particle size of about 1 micron is obtained. Degassing of the resulting emulsion is accomplished by use of a nitrogen sparge. After degassing, the reaction is initiated by use of sulfur dioxide and tertiary butyl hydrogen peroxide (tBHP) at a temperature of ˜20° C. The resulting reaction mass is allowed to heat up as a result of the reaction exotherm to a temperature of ˜85° C. A stable resulting product is obtained from this process. The characteristics of the end product are outlined as example 1B.

| | | | RESULTING | RESULTING | INTRINSIC |
|---|---|---|---|---|---|
| | HLB | EMULSIFYING | ACTIVE | MEAN | VISCOSITY |
| | SURFACTANT | SURFACTANT | POLYMER | PARTICLE | OF |
| EX | BLEND | Wt. % | SOLIDS | SIZE | POLYMER |
| 1A | 4.3 | 2.3% | 40% | 1.0 microns | 14 dl/g |
| 1B | 4.3 | 2% | 30% | 1.0 microns | 16 dl/g |

For both examples (1A and 1 B), the mean particle size of the resulting product is measured using a HORIBA LA-910 Particle Size Analyzer. The intrinsic viscosity of the resulting product is measured by use of a Schott-Gerate suspended level viscometer and 1 N salt buffer.

### EXAMPLE 2A

### Comparative

A conventional microemulsion comprising 28% copolymer by weight is prepared using standard means of microemulsion polymerization. The copolymer component of the emulsion contains 40% ammonium acrylate and 60% acrylamide thus making the copolymer 40% anionic in nature. The standard means of microemulsion polymerization involves preparation of the aqueous phase, preparation of the oil phase which contains 7.1% of an emulsifying surfactant blend with an HLB value of 9.1, and the mixing of the two phases together to allow the surfactants present to form the emulsion. No mechanical homogenization was employed. Primary constituents of the oil phase and aqueous phase are outlined below.

Aqueous Phase:

| | | |
|---|---|---|
| Acrylic Acid @ 100.0% | 112.0 | g |
| Acrylamide @ 50.0% | 336.0 | g |
| Ammonium Hydroxide | 85.0 | g |
| Water | 74.0 | g |

Oil Phase:

| | | |
|---|---|---|
| Naphthenic/Paraffenic oil | 300.0 | g |
| Sorbitan Sesquioleate (HLB value 3.7) | 12.0 | g |
| Polyoxyethylene Sorbitol Hexoleate | 59.0 | g |
| (HLB value 10.2) | | |

Degassing of the resulting emulsion is accomplished by use of a nitrogen sparge. After degassing, the reaction is initiated by use of sulfur dioxide and tertiary butyl hydrogen peroxide (tBHP) at a temperature of ˜20 C. The resulting reaction mass is allowed to heat up as a result of the reaction exotherm to a temperature of ˜40° C. where the polymerization is maintained with cooling. A stable resulting product is obtained from this process. The characteristics of the end product are outlined as example 2A.

| | | | | | RESULTING |
|---|---|---|---|---|---|
| | HLB OF | | RESULTING | RESULTING | INTRINSIC |
| | EMULSIFYING | EMULSIFYING | ACTIVE | MEAN | VISCOSITY |
| | SURFACTANT | SURFACTANT | POLYMER | PARTICLE | OF |
| EX | BLEND | ADDED | SOLIDS | SIZE | POLYMER |
| 2A | 9.1 | 7.1% | 28% | 0.2 microns | 27 dl/g |

Mean particle size of the resulting product is measured using a HORIBA LA-910 Particle Size Analyzer. The intrinsic viscosity of the resulting product is measured by use of a Schott-Gerate suspended level viscometer and 1 N salt buffer.

### EXAMPLE 3

Preparation of a microemulsion with an active polymer content of >35 weight % is attempted by using standard means of microemulsion polymerization. The desired copolymer component of the emulsion is 80% dimethylaminoethyl acrylate quaternized with methyl chloride and 20% acrylamide thus producing an 80% cationic copolymer. The standard means of microemulsion polymerization involves preparation of the aqueous phase, preparation of the oil phase containing varying levels of emulsifying surfactants at varying HLB values, and mixing of the two phases together to allow the surfactants present to form the emulsion. No mechanical homogenization is employed. Primary constituents of the oil phase and aqueous phase are outlined below.

Aqueous Phase:

| | | |
|---|---|---|
| Acrylamide @ 50.0% | 180.0 | g |
| Dimethylaminoethyl Acrylate @ 80.0% | 450.0 | g |
| Water | 10.0 | g |

Oil Phase:

| | | |
|---|---|---|
| Naphthenic/Paraffenic oil | 276.0 | g |

| | |
|---|---|
| Sorbitan Sesquioleate (HLB value 3.7) | varied as outlined below |
| Polyoxyethylene Sorbitol Hexoleate | varied as outlined below |
| (HLB value 10.2) | |

Degassing of the resulting emulsion is accomplished by use of a nitrogen sparge. After degassing, the reaction is initiated by use of sulfur dioxide and potassium bromate at a temperature of ˜20° C. The resulting reaction mass was allowed to heat up as a result of the reaction exotherm to a temperature of ˜40° C. where the polymerization was maintained with cooling. Consistent with prior art, a successful polymerization could not be achieved. Examples of attempted polymerizations and the variables used are as follows:

| | HLB OF | | INTENDED | |
|---|---|---|---|---|
| | EMULSIFYING | EMULSIFYING | ACTIVE | |
| | SURFACTANT | SURFACTANT | POLYMER | |
| EX | BLEND | ADDED | SOLIDS | RESULT |
| 3A | 9.75 | 8% | 40% | ¹Polymeriza- |
| | | | | tion failed |
| 3B | 9.75 | 8% | 37.5% | Polymeriza- |
| | | | | tion failed |
| 3C | 9.75 | 10% | 40% | Polymeriza- |
| | | | | tion failed |
| 3D | 7.5 | 4.8% | 45% | Polymeriza- |
| | | | | tion failed |

¹Polymerization failed means that the attempted polymerization gave destabilized emulsion that resulted in a viscous mass.

### EXAMPLE 4A THRU 4F

Preparation of the class of products of the invention is achieved using the process of the invention. In all cases, an active polymer content at about 40% or above is obtained. Surfactant levels for forming the emulsion are reduced drastically as compared to conventional microemulsion technology.

The polymerization process of the invention involves preparing of the aqueous phase, preparing of the oil phase containing varying levels of emulsifying surfactants at varying HLB values, and mixing of the two phases together. Heat is applied to the mixture to raise the temperature above 35° C. to allow for the formation of the emulsion and this temperature is maintained. Degassing by nitrogen sparging is done after the emulsion temperature is raised. No mechanical homogenization is employed other than simple stirring. The primary constituents of the oil phase and aqueous phase are outlined below:

Aqueous Phase:

| | | |
|---|---|---|
| Acrylamide @ 50.0% | 180.0 | g |
| Dimethylaminoethyl Acrylate @ 80.0% | 450.0 | g |
| Water | 10.0 | g |

Oil Phase:

| | | |
|---|---|---|
| Naphthenic/Paraffenic oil | 276.0 | g |

| | |
|---|---|
| Sorbitan Sesquioleate (HLB value 3.7) | varied as outlined below |
| Polyoxyethylene Sorbitol Hexoleate | varied as outlined below |
| (HLB value 10.2) | |

Degassing of the resulting emulsion is accomplished by use of a nitrogen sparge After degassing, the reaction is initiated by use of sulfur dioxide and potassium bromate. The polymerization is maintained at ˜40° C. with cooling. Examples of successful preparations and a summary of the variables used to achieve the end products are as follows:

| | | HLB OF | | | | | ³INTRINSIC |
|---|---|---|---|---|---|---|---|
| | | EMULSIFYING | | ²ACTIVE | MEAN | | VISCOSITY |
| | POLYMER | SURFACTANT | ¹SURF. | POLYMER | PARTICLE | | OF |
| EX | TYPE | BLEND | ADDED | SOLIDS | SIZE | | POLYMER |
| 4A | Copolymer of | 7.5 | 4.8% | 45% | 0.30 | microns | 17 dl/g |
| | 80% DMAEA | | | | | | |
| | and 20% | | | | | | |
| | acrylamide | | | | | | |
| 4B | Copolymer of | 9.75 | 8.0% | 40% | 0.25 | microns | 14 dl/g |
| | 80% DMAEA | | | | | | |
| | and 20% | | | | | | |
| | acrylamide | | | | | | |
| 4C | 100% | 9.8 | 4.3% | 50% | 0.30 | microns | 10 dl/g |
| | homopolymer | | | | | | |
| | of sodium | | | | | | |
| | acrylate | | | | | | |
| 4D | 100% | 7.5 | 3.5% | 45% | 0.28 | microns | 15 dl/g |
| | homopolymer | | | | | | |
| | of acrylamide | | | | | | |
| 4E | Copolymer of | 7.5 | 3.5% | 40% | 0.28 | microns | 16 dl/g |
| | 40% | | | | | | |
| | ammonium | | | | | | |
| | acrylate and | | | | | | |
| | 60% | | | | | | |
| | acrylamide | | | | | | |
| 4F | Copolymer of | 6.5 | 3.5% | 40% | 0.20 | | 38 dl/g |
| | 40% | | | | | | |
| | ammonium | | | | | | |
| | acrylate and | | | | | | |
| | 60% | | | | | | |
| | acrylamide | | | | | | |

NOTE:
DMAEA = dimethylaminoethylacryate quaternized with methyl chloride
¹Percent surfactant refers to total weigh of combination of surfactants based on total weight of the emulsion.
²Percent active polymer solids refers to the total polymer formed during the emulsion polymerization based on the total weight of the emulsion.
³Intrinsic viscosity units are decimeter per gram. The prepared solution is poured into a suspended level viscometer and the amount of time taken for the solution to flow between two lines on the viscometer is measured.

For all the examples above, the mean particle size of the resulting product is measured using a HORIBA LA-910 Particle Size Analyzer. The intrinsic viscosity of the resulting product is measured by use of a Schott-Gerate suspended level viscometer and 1 N salt buffer.

### EXAMPLE 5

The resulting polymer prepared of Example 4D is used as the polyacrylamide base for the preparation of a Mannich polyacrylamide emulsion. Dimethylaminomethanol (DMAM) was prepared by reacting 7.7 g of 95% paraformaldehyde with 27.5 g of a 55% solution in water of dimethylamine and 6.6 g of deionized water in a 100 ml flask keeping the exotherm below 45° C.

The Mannich polyacrylamide emulsion is prepared by warming 30 g of the base prepared in Example 4D to 30° C. and adding 26.5 g of the DMAM solution at a slow rate, <0.1 ml/min, with gentle stirring. The resulting Mannich polyacrylamide emulsion is stored until use at room temperature.

Optionally this Mannich polyacrylamide may be quaternized by treating with dimethyl sulfate or methyl chloride to recover a quaternized product. A foam-breaker surfactant, Tergitol 15-S-7 (1.5%) may be added to the product before or after quaternization of the Mannich polymer.

### EXAMPLE 6

The polymer outlined in Example 4A is dehydrated under reduced pressure and at an elevated temperature of 50-80° C. with the inclusion of a polymeric stabilizer to make the system resilient to the stress of distillation. This may optionally include the use of recyclable solvent to assist in the water removal. A liquid dispersion of the polymer in oil containing <5% water is obtained. The active solids are increased from 45% to 50% by this method.

### EXAMPLE 7

The resulting polymer of Example 4D is used as the polyacrylamide base for the preparation of a glyoxalated polyacrylamide emulsion. The glyoxalated polyacrylamide emulsion is prepared by warming 30 g of the base prepared in Example 4D to 30° C., by adding a sufficient amount of sodium carbonate solution to adjust the pH to 8.0-9.0, and then by adding 13.5 g of 40% glyoxal. After 6 hours, the pH of the system is adjusted to 2.5-3.5 by the addition of sulfuric acid and the gloxylated polyacrylamide stored until use.

Optionally the glyoxalted polyacrylamide may be produced by prior reaction of the glyoxal with the acrylamide monomer and then following the preparation outlined in Example 4D.

### APPLICATION EXAMPLES

### EXAMPLE 8

The testing of the dewatering properties of examples 4A and 4B for use in water and wastewater treatment is carried out on both municipal sewage sludges and industrial sludges using example 1A as the benchmark. Testing is carried out using free drainage testing. Free drainage testing comprises treating 200 ml aliquots of sludge with 0.2% solutions of the polymer samples under shear conditions of 1000 rpm for 10 seconds. The flocculated sludge is allowed to drain through filtration media for a period of five seconds. The volume of filtrate collected after five seconds is recorded. Free drainage volume as a function of applied dosage for each sample is used for comparison. Examples 4A and 4B exhibit equivalent dosage requirements and drainage. Both exhibit a 13.2% active dosage reduction and a 14.9% drainage increase on average as compared to example 1A.

### EXAMPLE 9

The testing of the retention properties of example 4E for use in papermaking is carried out on samples of a synthetic stock consisting of 50% hardwood, 50% softwood and 25% precipitated calcium carbonate filler using example 1B as the benchmark. Products are applied in conjunction with a constant alum dosage of 4 pound per ton. The flocculent dosage is varied between 0.3, 0.6 and 0.9 pounds per ton (based on active polymer). First pass retention and first pass ash retention is tested using the industry standard Britt jar test. The % retention as a function of applied dosage for each sample is plotted.

% Retention

| Dosage lb/ton | Example 4E | Example 1B |
|---|---|---|
| 0.3 | 75.34 | 75.08 |
| 0.6 | 78.72 | 77.95 |
| 0.9 | 81.74 | 80.98 |

The data demonstrates the improved retention of Example 4E as compared to the conventional product of equivalent anionic charge and molecular weight, Example 1B.

Stability Testing

### EXAMPLE 10

Both freeze/thaw stability testing and accelerated aging testing is carried out on example 1A and 4A. Freeze/thaw testing is carried out by subjecting a 100 ml aliquot of each sample to four cycles of freezing and thawing. One cycle consists of a 16 hour freeze period at −38° C. followed by an eight hour thaw period at room temperature. Each sample is visually assessed at the end of the thaw period for each cycle. The number of cycles completed without adverse effects being observed is recorded for each sample. Example 1A is noted as becoming an unstable gelatinous mass after three cycles. No adverse effects to example 4A are noted thus demonstrating its superior stability as compared to example 1A.

Accelerated stability testing is carried out by subjecting a 100 ml aliquot of each sample to a continuous temperature of 60° C. Samples are visually assessed every 24 hours and the number of 24 hour periods completed without adverse effects being observed is recorded for each sample. It is known that this test accelerates the rate at which a sample will destabilize and separate into two or three distinct phases. Within the industry, this separation is undesirable and makes the product either difficult to use or unuseable. It is also known within the industry that one month under these test conditions approximates a six month period. Under these test conditions, solids within Example 1A are noted as separating and depositing at the bottom of the sample container after 26 twenty-four hour periods equating to a 5.2 month shelf life. No adverse effects to example 4A are noted after 60 periods equating to a one year shelf life, thus demonstrating its superior stability as compared to example 1A.

Dewatering of Municipal Sewage Sludge

### EXAMPLE 11

The testing of the dewatering properties of examples 4A and 4B for use in water and wastewater treatment is carried out on municipal sewage sludge using example 1A as the benchmark. Testing is carried out using Alfa Laval Sharples model DS 706 centrifuges to dewater digested pure oxygen waste activated sludge. Sludge flow to the centrifuge is in the range 150 gpm to 180 gpm (gallons per minute) depending upon plant requirements. The centrifuges are run with torque set at 40% and the differential is allowed to drift to maintain this load. Polymer is made into a solution using one of two Polyblends that operate on a duty/standby basis. Dilute polymer solution is applied to the sludge line in two places, 30% immediately before the centrifuge and 70% into the centrifuge bowl. Cake with minimum dry solids of 26.50% is required. Examples 4A and 4B exhibit equivalent dosage requirements and cake dry solids. Both exhibit an active dose reduction of 20% whilst maintaining cake solids at the same level when compared with example 1A.

| | Example 4A | Example 1A |
|---|---|---|
| Dosage Required to Generate | 18.48 lb/dry ton | 23.09 lb/dry ton |
| Cake of 26.50% | | |

Papermaking Using an Anionic Polymer of the Invention

### EXAMPLE 12

A papermaking trial is conducted on a pilot papermaking machine. The cellulosic suspension consists of 60% hardwood and 40% softwood refined to 350 ml Canadian Standard Freeness with a thin stock consistency of 0.5%. About 5 kgs/ton of cationic starch is included together with 20% precipitated calcium carbonate (PCC). Alum is present in an amount of 2.5 kg/ton. The kg/ton and % PCC are based on the dry weight of the cellulosic suspension.

The thin stock is first treated with a cationic acrylamide copolymer containing 9 mole % DMAEA.MeCl quaternary salt having an IV about 10 dl/g. The resulting flocculated suspension is degraded by its passage through the fan pump and centriscreen. A solution of an anionic copolymer (made from ˜40% by weight sodium acrylate and ˜60% acrylamide copolymer in a concentration of about 0.5 to 1 kg/ton) is added between the centriscreen and the headbox. The suspension is then drained through the wire, and the first pass retention, first pass ash retention and formation are recorded.

In run 1 the second polymer is a copolymer of acrylamide and sodium acrylate (also ˜40 wt. % sodium acrylate) and is made in the presence of 4 ppm of methylene bisacrylamide according to the process of the invention.

In run 2 the second polymer is of identical composition as that employed in run 1 but is made by the method of classical inverse macro-emulsion techniques.

The copolymer in run 1 causes an increase in retention, both first pass retention and first pass ash retention, improving paper formation.

### EXAMPLE 13

### Papermaking Using Cationic Polymer (−20% by Wt. Cationic DMAEA.MeCl Quaternary Salt and Acrylamide) of the Invention

Britt jar tests are carried out upon a neutral pH stock consisting of hardwood (35%), softwood (65%). Calcium carbonate is added to the stock as a filler to the level of 25%. The stock contains a conventional sizing agent and 0.5% starch as a strengthening aid.

The shear condition of the Britt Jar is adjusted to give a first pass retention in the region of 55% in the absence of any further additive.

A cationic polyacrylamide prepared by the invention is added to 500 ml of the stock at 0.6% pulp consistency in a measuring cylinder. The cylinder is inverted four times to achieve mixing and the flocculated stock is transferred to the Britt jar tester. The stock is sheared for one minute. A bentonite suspension is then added to the sheared suspension and the retention performance is observed. All percents are by weight and based on the dry weight of the stock.

In a subsequent run a cationic polyacrylamide of identical formulation produced by classical macro-inverse emulsion techniques is employed.

Retention performance and drainage rate are improved by the use of the copolymer formed by the method of the invention.

### EXAMPLE 14

Mineral Processing

1000 ml samples of red mud underflow from the last washer stage in a Bayer alumina process are obtained prior to the centrifugation stage. The mud solids are approximately 25%. A water-soluble copolymer of acrylamide with sodium acrylate, prepared according to the process of the invention is applied to the samples of red mud at various dosage levels. The treated mud is gently agitated in a lab tumbler for one hour in order to simulate the normal residence time required for the red mud to flow through a pipeline to the disposal site. The samples of treated mud are then poured onto a level surface to form a stack. This is meant to simulate the ability of the mud to form stacks.

The mud using the polymer prepared by the method of the invention forms stable stacks.

Soil Testing

Polyvinyl chloride (PVC) pipes that are 6 inches in height and 2 inches in diameter are obtained. At the bottom end of each pipe, a paper filter is attached. Each pipe is set up vertically, with the paper end on the bottom, and is filled with the same silty soil type to within one inch of the top of the pipe. A polyacrylamide acrylic acid (−80 wt. % acrylamide and 20 wt. % acrylic acid sodium salt) copolymer is prepared according to the invention is dissolved in water and applied to the soil surface (−5 lbs active polymer in 750 gallons of water). One teaspoon of this water solution is the amount added to the soil surface. Enough water, containing no test compounds, is then added to bring the level to the top of the pipe. The leakage rate is determined by the amount of time required to dissipate one inch of water.

The addition of the polyacrylamide-sodium acrylate effectively slows the leakage rate of water through the soil.

1. A process for preparing a polymeric inverse emulsion, which process comprises the steps of
(a) admixing;
(i) an oil phase composition comprising at least one hydrocarbon liquid;
(ii) an effective amount of a surfactant or mixture of surfactants or mixture of surfactant and co-surfactant;
(iii) an aqueous phase comprising at least one monomer selected from the group consisting of ethylenically unsaturated cationic monomers, ethylenically unsaturated anionic monomers, ethylenically unsaturated amphoteric monomers and ethylenically unsaturated nonionic monomers, and optionally,
(iv) at least one cross-linking agent,
so as to form an inverse emulsion;
(b) heating the inverse emulsion formed in step (a) to a temperature of about 28 to about 50° C.;
(c) degassing the heated inverse emulsion formed in (b);
and,
(d) polymerizing the monomer or monomers of the emulsion formed in (c) to form the polymeric inverse emulsion.

2. A process according to claim 1 wherein the inverse emulsion formed in step (a) is heated to a temperature of about 30 to about 40° C.

3. A process according to claim 1 wherein the steps are carried out continuously or in a batch mode.

4. A process according to claim 1, wherein the admixing of (i) through (iv) in step (a) can be in any order.

5. A process according to claim 1, wherein the aqueous phase of (iii) further comprises other conventional additives.

6. A process according to claim 5, wherein the conventional additives are selected from the group consisting of chelating agents, pH adjusters, thermal and redox initiators, and organic compounds and redox couples.

7. A process according to claim 1, wherein the polymer formed in step (d) is greater than about 30% by weight of the total inverse emulsion.

8. A process according to claim 7, wherein the polymer formed in step (d) is greater than about 35% by weight of the total inverse emulsion.

9. A process according to claim 1, wherein the polymeric inverse emulsion in step (d) contains a polymer solution and the polymer is a particle.

10. A process according to claim 9, wherein the particle has a mean diameter of less than about 0.7 microns.

11. A process according to claim 1, wherein at least one monomer is selected from the group consisting of ethylenically unsaturated cationic monomers.

12. A process according to claim 1, wherein at least one of the ethylenically unsaturated monomers is non-ionic.

13. A process according to claim 11, wherein the cationic monomer is a formula (I) or (II) 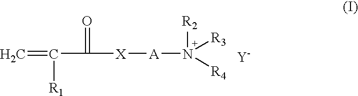
where R₁ is hydrogen or methyl;
R₂ is hydrogen or C₁-C₄ alkyl;
R₃ and R₄ are the same or different and independently represent hydrogen, C₁-C₄ alkyl, C₁-C₁₂ aryl, phenylalkyl, or hydroxyethyl;
R₂ and R₃ or R₂ and R₄ can combine to form a 5 or 6 membered ring containing one or more hetero atoms;
Y⁻ is the conjugate base of an acid;
X is oxygen or —NR₁ wherein R₁ is independently defined as above,
and
A is a C₁C₁₋₂alkylene group; 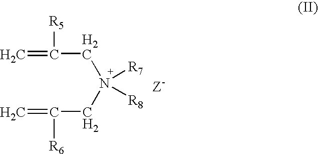
where R₅ and R₆ are hydrogen or a C₁-C₄ alkyl;
R₇ and R₈ are, independently, hydrogen, alkyl, hydroxyalkyl, carboxyalkyl, carboxyamide, phenylalkyl, or alkoxyalkyl;
and
Z⁻ represents an anion.

14. A process according to claim 1, wherein the non-ionic monomer are selected from the group consisting of acrylamide, methacrylamide, N-methyl(meth)acrylamide, N,N-dimethyl(meth)acrylamide, N-isopropyl(meth)acrylamide, N-(2-hydroxypropyl)(meth)acrylamide, N-methylolacrylamide, N-vinylformamide, N-vinylacetamide, N-vinyl-N-methylacetamide, fumaramide, monomethyl ether mono(meth)acrylate, N-vinyl-2-pyrrolidone, glycerol mono((meth)acrylate), 2-hydroxyethyl(meth)acrylate, vinyl methylsulfone, vinyl acetate, diacetone acrylamide, diesters of maleic, fumaric, succinic and itaconic acids, methyl (meth)acrylate, ethyl (meth)acrylate, hexyl (meth)acrylate, octyl (meth)acrylate, stearyl (meth)acrylate, stearyl ethoxy (meth)acrylate, stearyl ethoxy allyl ether and mixtures thereof.

15. A process according to claim 14, wherein the non-ionic monomer is selected from the group consisting of acrylamide, methacrylamide, N-methylacrylamide, N,N-dimethylacrylamide; methyl acrylate; methyl methacrylate, hydroxyethyl(meth)acrylates, hydroxypropyl(meth)acyrlates, hydroxylmethyl(meth)acyrlates, acrylonitrile, N-vinyl methylacetamide, N-vinyl methyl formamide; N-vinyl pyrrolidone, and mixtures thereof.

16. A process according to claim 15, wherein the non-ionic monomer is acrylamide.

17. A process according to claim 16, further comprising a functionalizing agent.

18. A process according to claim 17, wherein the functionalizing agent is formaldehyde and a secondary amine or glyoxal.

19. A process according to claim 1, wherein the steps further comprise adding, after the polymer is formed in the inverse emulsion, a functionalizing agent to the inverse emulsion and funtionalizing the formed polymer within the inverse emulsion.

20. A process according to claim 1, wherein the oil phase comprises an isoparafinic hydrocarbon or mixtures thereof.

21. A process according to claim 1, wherein at least one surfactant is selected from the group consisting of polyoxyethylene (20) sorbitan trioleate, polyoxyethylene sorbitol hexaoleate, polyoxyethylene sorbitol heptaoleate, sorbitan sesquioleate, sorbitan trioleate, sorbitan monostearate, sorbiton monooleate, sodium di-2-ethylhexylsulfosuccinate, oleamidopropyldimethylamine; sodium isostearyl-2-1actate, glyceryl monooleate and ethoxylated fatty alcohols and mixtures thereof.

22. A process according to claim 1, wherein the surfactant comprises about 2 to 12 weight percent based on the weight of the polymeric inverse emulsion.

23. A process according to claim 1 wherein the polymer of the polymeric inverse emulsion formed in step (d) is further reacted with at least one functionalizing agent.

24. A product prepared by a polymeric inverse emulsion process, which process comprises
(a) admixing;
(i) an oil phase composition comprising at least one hydrocarbon liquid;
(ii) an effective amount of a surfactant or mixture of surfactants or mixture of surfactant and co-surfactant;
(v) an aqueous phase comprising at least one monomer selected from the group consisting of ethylenically unsaturated cationic monomers, ethylenically unsaturated anionic monomers, ethylenically unsaturated amphoteric monomers and ethylenically unsaturated nonionic monomers, and optionally,
(vi) at least one cross-linking agent,
so as to form an inverse emulsion;
(b) heating the inverse emulsion formed in step (a) to a temperature of about 28 to about 50° C.;
(c) degassing the heated inverse emulsion formed in (b);
and,
(d) polymerizing the monomer or monomers of the emulsion formed in (c) to form the polymeric inverse emulsion,
wherein the polymeric inverse emulsion product is stable for at least 6 months at 25° C.

25. A process for preparing a polymeric inverse emulsion, which process comprises the steps of
(a′) heating an oil phase composition comprising at least one hydrocarbon liquid and an effective amount of a surfactant, mixture of surfactants or mixture of surfactant and co-surfactant;
(b′) admixing
an aqueous phase comprising at least one ethylenically unsaturated monomer selected from group consisting of ethylenically unsaturated cationic monomers, ethylenically unsaturated anionic monomers, ethylenically unsaturated amphoteric monomers and ethylenically unsaturated nonionic monomers and mixtures thereof, and optionally at least one cross-linking agent with the heated oil phase composition in step (a′) so as to form a heated inverse emulsion, wherein the temperature of the combined oil phase and aqueous phase is about 28 to about 50° C.;
(c′) degassing the heated emulsified mixture formed in (b′);
and,
(d′) polymerizing the mixture formed in (c′) to form the polymeric inverse emulsion.

26. A polymeric inverse emulsion which comprises
(I) a hydrocarbon phase and an aqueous phase, wherein the hydrocarbon phase comprises about 2 to about 9 weight percent,
and
(II)a polymer, wherein the polymer making up the polymeric inverse emulsion is equal to or greater than about 35 weight percent,
wherein the polymer is in the form of a polymer phase droplet which droplet is a particle having an average mean diameter size of about equal to or less than about 0.5 microns and all weight percents are based on the total weight of the emulsion.

27. A polymeric inverse emulsion according to claim 26, wherein the polymer is formed from at least one monomer selected from the group consisting of cationic ethylenically unsaturated monomers, anionic ethylenically unsaturated monomers, amphoteric ethylenically unsaturated monomers and non-ionic ethylenically unsaturated monomers.

28. A polymeric inverse emulsion according to claim 27 wherein the polymer is formed from at least one cationic ethylenically unsaturated monomer.

29. A polymeric inverse emulsion according to claim 27 wherein the polymer is formed from at least one anionic ethylenically unsaturated monomer.

30. A polymeric inverse emulsion according to claim 26 wherein the polymer is formed from at least one ethylenically unsaturated non-ionic monomer.

31. A polymeric inverse emulsion according to claim 30 wherein the non-ionic monomer is acrylamide.

32. A polymeric inverse emulsion according to claim 27 wherein the polymer is formed from a cationic monomer and a non-ionic monomer.

33. A polymeric inverse emulsion according to claim 26 wherein the hydrocarbon phase comprises a isoparafinic hydrocarbon or mixtures thereof.

34. A polymeric inverse emulsion according to claim 33 wherein the isoparafinic hydrocarbon phase comprises mineral oil, toluene, fuel oil, kerosene, odorless mineral spirits or mixtures thereof.

35. A process for dewatering organic and inorganic suspensions which comprises adding the composition of claim 26 to the suspension.

36. A process for making paper or paperboard comprising forming a cellulosic suspension, which comprises adding the composition of claim 26 to the suspension, draining water from the suspension to form a wet sheet and drying the sheet to form the paper or paperboard.

37. A process for dewatering organic and inorganic suspensions which comprises adding the inverse emulsion formed in claim 1 to the suspension.

38. A process for making paper or paperboard comprising forming a cellulosic suspension, which comprises adding the inverse emulsion formed in claim 1 to the suspension, draining the water from the suspension to form a wet sheet and drying the sheet to form the paper or paperboard.

39. A process for modifying the rheology of a paint, paste, coating, or ink formulation which comprises adding a composition according to claim 26 thereto.

40. A process for modifying the rheology of a paint, paste, coating, or ink formulation which comprises adding an inverse emulsion formed as in claim 1 thereto.
